(19) United States
(12) Patent Application Publication
(10) Pub. No.: US 2025/0237014 A1
(43) Pub. Date: Jul. 24, 2025

(54) SYSTEM AND METHOD OF REAL-TIME ENZYMATIC ACTIVITY DETECTION AND DYNAMIC FORMULATION FOR PULP AND PAPER PRODUCTION

(71) Applicant: Buckman Laboratories International, Inc., Memphis, TN (US)

(72) Inventors: Helen Brantley, Germantown, TN (US); Deborah Marais, Memphis, TN (US)

(21) Appl. No.: 19/030,045

(22) Filed: Jan. 17, 2025

Related U.S. Application Data
(60) Provisional application No. 63/623,201, filed on Jan. 19, 2024.

(51) Int. Cl. D21H 17/00; D21H 23/08; G01N 27/327

(52) U.S. Cl. CPC D21H 17/005; D21H 23/08; G01N 27/3271; G01N 27/3275

(57) ABSTRACT

Systems and methods as disclosed herein automatically provide real-time dosing corrections for industrial processes wherein enzymatic compositions are applied to natural fibers for producing a pulp/paper product. Predictive models are developed to correlate observed properties of various products with various combinations of process inputs including enzyme blend characteristics. For a current process, an initial enzyme blend and respective dose rates for components thereof is selected based on target properties for the pulp/paper product. Upon application of the initial enzyme blend, real-time feedback data is provided corresponding to measured actual values for enzyme activity of at least one enzyme blend component. During the industrial process, respective dose rates for at least one of the one or more components of the enzyme blend are selectively and dynamically adjusted, based at least in part on the measured enzyme activity.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of U.S. Provisional Patent Application No. 63/623,201, filed Jan. 19, 2024, and which is hereby incorporated by reference in its entirety.

### FIELD OF THE INVENTION

The present invention relates generally to systems and methods for component characterization and feedback implementation in industrial processes.

More particularly, embodiments of inventions as disclosed herein relate to systems and methods for optimizing enzyme selection and dosing, for example in pulp and paper production, and further proactively correcting enzyme component dosing in real time based on types of feedback that could include the direct or indirect measurement of enzymatic activity, as well as other properties such as fiber length, width, curl, kink, freeness or drainage, porosity, tensile, internal bond, compression, ring crush, pH, temperature, conductivity, sulfite content, hydrogen peroxide content, and chloride content, etc.

### BACKGROUND

Conventional paper making processes may generally include: the formation of an aqueous suspension of cellulosic fibers, commonly known as pulp; adding various processing and paper enhancing materials, such as strengthening, retention, drainage aid, and/or sizing materials, or other functional additives; sheeting and drying the fibers to form a desired cellulosic web; and post-treating the web to provide various desired characteristics to the resulting paper, such as surface application of sizing materials, and the like. Various types of enzymatic compositions, of various enzyme dose ratios, may accordingly be applied to treat the fibers to improve properties of the pulp (e.g., improve the drainage of the fiber suspension slurry) and/or the properties of the finished sheet (e.g., strength, porosity, softness).

As pulp and paper producers purchase and/or produce fiber and undertake grade development activities, the properties of the fiber are observed to change as a result of multiple reasons including, but not limited to, the species of tree used in generating the fibers, the blend of fiber used, whether a fiber is virgin or recycled, tree growth conditions, seasonality, pulping process, pulp treatment, and the like. This introduces inherent variability into their process and can alter the type and amount of enzyme that should be dosed to a system for the application of bleaching and/or fiber modification enzymes. Adding the wrong mix or dose of enzymes may result in unnecessary activities, waste in chemical spend, or over-development of the fiber, further resulting in lost efficiency.

When a pulp/paper mill needs to change furnish, for example from a hardwood to a softwood to a recycled furnish, this would require the shipment of many different types of enzyme formulations to meet those needs. If a pulp/paper mill desired to change fiber furnish, one type of enzyme formulation may not be the best for a particular furnish and require a new formulation. To expedite the ability to increase flexibility of the use of enzymes with different furnish changes at a pulp/paper mill, the use of more concentrated raw materials that can be formulated on-site faster rather than waiting on deliveries of a custom-made product is more efficient.

However, on-site formulation of enzymatic solutions using conventional techniques may be flawed due to an inability to properly account for enzymatic activity from both a quality of formulation perspective and an assurance of activity on the substrate. Expected performance may or may not occur, and without explanation as to why the product did not perform as expected. Certain storage conditions can contribute to loss of enzymatic activity, but there are numerous other variables within the process system at a pulp or paper mill, that can affect product performance of the enzyme, such as the fibers being coated with stickies, lignin, or other pulp/paper additives that prevent the enzymes from reaching and acting on the fiber surface.

Conventional systems and methods are known to implement limited examples of fiber surface characterization, fiber quality analysis, and sensors for measuring industrial process conditions.

However, such conventional techniques are substantially limited in that they utilize technology that cannot determine if the lack of expected final paper properties are due to unknown factors such as, but not limited to, enzyme inhibition molecules, reduced enzyme binding to specific species of fiber, or under-dosage or over-dosages of enzyme blends. Accordingly, conventional techniques typically focus on a single piece of the enzyme selection and formulation process, rather than providing or otherwise enabling the implementation of a more holistic framework.

Methods such as spectrophotometric techniques are known in the art for determining enzymatic activity at a pulp/paper mill, but may for example require lengthy wait times. This technique also typically requires the immediate interaction of an on-site representative with a hands-on approach rather than through the use of an in-line sensor without the need for an individual to complete the assay in-person. Other known techniques for determining enzymatic activity on a fiber may include tracking an increase or decrease in paper strength properties as a function of time for tensile strength, burst, internal bond strength, etc., but again these properties cannot approximate real-time feedback. These properties do not give information on whether the enzyme dosage or enzyme blend could have been better optimized.

### BRIEF SUMMARY

Generally stated, systems and methods as disclosed herein represent technical advancements over the prior art, at least in that they may utilize a database of information to provide algorithms for product selection and application that can be adjusted, substantially in real-time, using measurements of fiber and physical conditions, particularly including measurements representative of enzymatic activity. Such algorithms may be dynamic in nature based on observed correlations over time between various combinations of process inputs and desired outcomes in the form of fiber quality, product efficacy, and the like.

It is known that enzymes act as a catalyst and are not depleted like a chemical would be in a chemical reaction. If a process water system is closed in a paper mill to conserve water, the enzymatic concentration can increase over time. Enzymatic applications and dosages require knowledge around many different factors that play a role in achieving desired performance. This knowledge can assist operators to make decisions on paper-making processes. If desired effects of the enzyme are not observed, trouble-shooting steps can be taken to determine whether other factors of inhibition are at play. Data that we generate can create insights and trends during operation that can help correlate enzymatic action on substrates with seasonal changes, process changes, furnish changes, and more.

If a substrate is coated in an inhibitory substance, enzymes like cellulase, xylanase, and mannanase have limited access to the surface to bind with the substrate. If the inhibitory substance content in a mill is determined to be high, an enzymatic activity sensor could be used to pre-screen the best combination of enzymes that would act on a particular type of substrate depending on what the inhibitory content in the mill represents.

Certain enzymes are more effective on certain fiber surfaces than others. The surface structure, whether amorphous or crystalline, has an impact on the action of enzymes. Certain enzymes favor amorphous cellulose, while other enzymes that act on crystalline cellulose can be more aggressive. This can make product recommendations for enzyme formulations difficult if certain enzymes are needed to act on a varying substrate.

Systems and methods disclosed herein accordingly improve on conventional tools as described above, at least by utilizing online sensors, further optionally through the creation of surface films of various substrate coatings, to make product recommendations of enzyme formulations based on the observed enzymatic activity. While embodiments as disclosed herein may include for example cellulose-coated electrochemical substrates, the scope of the present disclosure readily encompasses alternative coated surfaces such as for example cellulose for cellulase, polyvinylalcohol for lipase, and more.

Systems as disclosed herein may preferably implement accessible visualization graphics, alarms, notifications, and the like via onboard user interfaces, mobile computing devices, web-based interfaces, etc., to supplement any automated capabilities with actionable insights relating to the associated processes.

Exemplary techniques for predictive model development may include machine learning, for example supervised and unsupervised learning, hard and soft clustering, classification, forecasting, and the like.

One objective of the present disclosure is to provide a database of several key fiber, enzyme, and system data points to identify an optimum enzyme blend and dose for a particular application. In short, a system and method may relate elements such as for example fiber surface substrate characterization, fiber quality analysis data (including elements like fiber length, fiber width, fibrillation, kink, curl, etc.), enzyme activity fingerprints, physical measurements from the process (pH, temperature, and flow rate/retention time), product efficacy data, and the like to provide an initial product blend and dose rate. The system can be implemented for an individual aspect of the overall process or may be implemented as part of a pumping skid that can blend multiple raw materials together to attain the optimum blend and dose rate. This skid may for example be integrated with online sensors of flow rate, temperature, chemical residual and pH, as well as system data relating to the strength, freeness and quality of the finished sheet, to determine if optimum dosing has been achieved. Furthermore, as data related to fiber quality and substrate prevalence is collected and uploaded to the system, the balance of the enzymatic raw materials present may be adjusted over time.

System outputs may for example feed into a dosing skid that would blend enzymatic raw materials for delivery straight into a pulp or papermaking application and may be particularly advantageous with respect to at least pulp bleaching and tissue/packaging/paper making applications.

The systems and methods as disclosed herein may further utilize a front-end data capture application that feeds information into the overall database, wherein such information may further be communicated to the blending and dosing skid either wirelessly or via integrated signals. Various sensors, controllers, online devices, and other intermediate components may be “Internet-of-things” (IoT) compatible, or otherwise comprise an interrelated network, wherein relevant outputs may be uploaded to a cloud-based server in real time.

In view of some or all of the aforementioned issues and objectives, a first exemplary embodiment of a method as disclosed herein automatically provides real-time dosing corrections for an industrial process wherein one or more enzymatic compositions are applied to fibers for producing a pulp or paper product, and includes, for each of a plurality of pulp or paper products, developing predictive machine learning models by observing correlations over time between outcomes, associated with properties for the respective pulp or paper product, and various combinations of process inputs, comprising characteristics of a respective enzyme blend. For a current pulp or paper product to be produced via the industrial process, the method further includes: using an associated model to select an initial enzyme blend to be applied, and respective dose rates for one or more components thereof, based at least in part on input data comprising one or more target properties for the pulp or paper product; upon application of the initial enzyme blend and respective dose rates for the one or more components thereof, providing real-time feedback data comprising measured values corresponding to enzyme activity of at least one of the one or more enzyme blend components; and during the industrial process, dynamically adjusting the respective dose rates for at least one of the one or more components of the enzyme blend, based at least in part on the measured enzyme activity.

In one exemplary aspect according to the above-referenced embodiment, the method may include predicting an inhibitory content associated with a substrate for the pulp or paper product, and selecting the replacement enzyme blend to be applied, and respective dose rates for one or more components thereof, based at least in part on the predicted inhibitory content.

An exemplary list of sensors for providing data by which inhibitory content may be predicted, or in other words types of relevant information for such predictions, may include without limitation sensors configured to generate output signals representative of hydrogen peroxide, sulfite, chloride, etc.

In another exemplary aspect according to the above-referenced embodiment, the method may include generating and retrievably storing correlations between at least measured enzyme activity and respective types of fiber surface substrates.

In another exemplary aspect according to the above-referenced embodiment, the one or more target properties comprise an expected fiber surface substrate characterization for the pulp or paper product, and/or an expected fiber quality characterization for the pulp or paper product.

In another exemplary aspect according to the above-referenced embodiment, a replacement enzyme blend to be applied, and respective dose rates for one or more components thereof, may be dynamically selected based at least in part on the measured enzyme activity and further on a predicted one or more target properties of the pulp or paper product corresponding to the replacement enzyme blend. The selected replacement enzyme blend may then be applied in place of at least a portion of the initial enzyme blend during the industrial process.

In another exemplary aspect according to the above-referenced embodiment, the method may include predicting an inhibitory content associated with a substrate for the pulp or paper product, and selecting the replacement enzyme blend to be applied, and respective dose rates for one or more components thereof, based at least in part on the predicted inhibitory content.

In another exemplary aspect according to the above-referenced embodiment, the real-time feedback data may comprise glucose detection signals and non-glucose enzyme activity detection signals.

In another exemplary aspect according to the above-referenced embodiment, the real-time feedback data may correspond to measured actual values of byproducts produced by enzymatic reactions associated with at least one of the one or more enzyme blend components.

In another exemplary aspect according to the above-referenced embodiment, the real-time feedback data may correspond to measured changes in electrochemical signals upon enzyme exposure. For example, the real-time feedback data may correspond to measured changes in impedance of a substrate surface coating upon enzyme exposure. The substrate may be coated with a cellulose-derived material, wherein an impedance measurement sensor may detect changes in the cellulose that is broken down by cellulases through electrical impedance measurements, and accordingly provide direct feedback measurements corresponding to the amount of enzyme in the solution. As one non-limiting example, such a sensor and associated outputs may be used to possibly detect the activity of cellulases on the cellulose coated surfaces.

In another exemplary and non-limiting embodiment, the substrate may be coated with a starch, which can be used to detect the presence of amylase, triglyceride-based surfaces for lipases, and the like.

In another exemplary aspect according to the above-referenced embodiment, the initial enzyme blend to be applied and the respective dose rates may be selected further based on expected values for one or more industrial process characteristics, wherein the real-time feedback data further comprises measured values for the one or more industrial process characteristics.

In another exemplary aspect according to the above-referenced embodiment, the method may further comprise selectively altering the predetermined model based at least in part on the provided real-time feedback data.

In another exemplary aspect according to the above-referenced embodiment, the selected initial enzyme blend and the dynamically selected replacement enzyme blend to be applied, and respective dose rates thereof, may be provided to a pulp bleaching process controller.

In another exemplary aspect according to the above-referenced embodiment, the selected initial enzyme blend and the dynamically selected replacement enzyme blend to be applied, and respective dose rates thereof, may be provided to a paper manufacturing controller.

In another embodiment, a system within the scope of the present disclosure may automatically provide real-time dosing corrections in an industrial process wherein one or more enzymatic compositions are applied to natural fibers for producing a pulp or paper product. A data storage unit comprises, for each of a plurality of pulp or paper products, predictive machine learning models correlating outcomes, associated with properties for the respective pulp or paper product, and various combinations of process inputs, comprising characteristics of a respective enzyme blend. One or more online sensors are configured to generate output signals representative of measured actual values for enzyme activity of at least one of one or more enzyme blend components during the industrial process. A production stage comprises a plurality of containers each configured to store and selectively deliver respective raw materials corresponding to selected enzyme blend components. A dosing control stage comprising one or more computing devices are functionally linked to the data storage unit and to the one or more online sensors and configured to direct the performance of steps in a method according to the above-referenced embodiment and optionally one or more of the exemplary aspects thereof.

Numerous objects, features, and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is a block diagram representing an exemplary embodiment of a system as disclosed herein.

FIG. 2 is a diagram and simplified flowchart representing an exemplary embodiment of a method as disclosed herein for initial product and dose selection and subsequent adjustment based upon fiber and system parameters.

### DETAILED DESCRIPTION

Briefly stated, systems and methods as disclosed herein may be implemented to correlate furnish, system, and enzymatic activity measurements to provide a tailored or otherwise optimized dosing regimen for an enzyme blend as needed to maintain the ideal properties of a finished pulp or paper product. In various embodiments, methods for enzymatic activity detection can include monitoring of byproducts produced from enzymatic reactions and/or increases in electrochemical signals upon enzymatic conversion of a substrate to be used in a pulp or paper mill. This information may for example be used in feedback control loops as further discussed herein for determination of the extent of fiber modification in real-time prior to the pulp being dried and prior to paper formation which will allow paper mills to more quickly make adjustments earlier in the process to attain desired paper strength and/or drainage (increased speed).

While the following description of embodiments of a system and method as disclosed herein may focus for illustrative purposes on the selection and formulation of one or more enzymes, one of skill in the art may appreciate the relevance of such methods in the corresponding selection and/or formulation of supporting components for enzymatic technologies such as non-ionic surfactants, polymers, etc., as potentially contributing to optimization of the system with respect to enzymatic activity. An enzyme and corresponding aids such as polymeric surfactants as used in systems and methods as disclosed herein may accordingly be supplied separately or collectively as an enzyme blend, the selection, formulation, and dynamic adaptation of which may be enhanced by various embodiments of the present disclosure. As used herein, terms such as enzymatic composition, enzymatic formulation, enzyme blend, or the like are not limited in scope to one or more enzymes, but further may include such aids, including for example non-enzymatic potentiators, as would be understood by one of skill in the art, the particular elements of such compositions, formulations, or blends being defined at least partially in view of the process or application at issue.

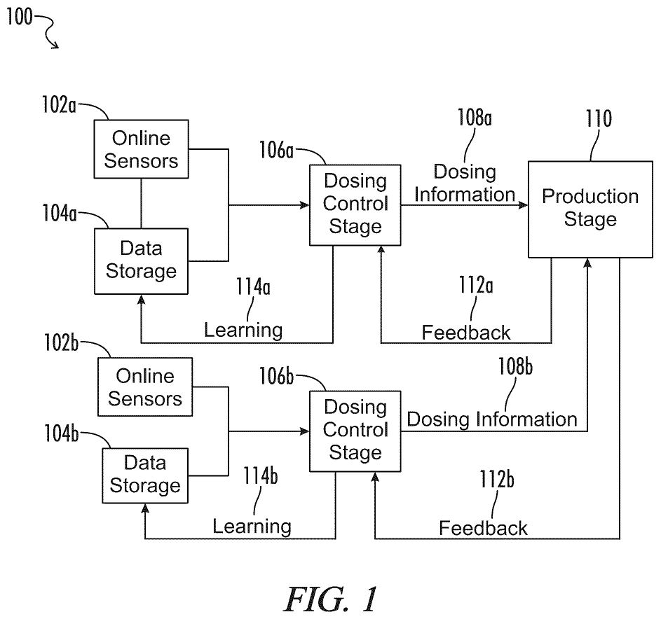

Referring initially to FIG. 1, a system 100 as disclosed herein may comprise multiple dosing control stages 106a, 106b, . . . 106x as illustrated in functional coordination with a production stage 110, e.g., a pulp or paper production stage, wherein each dosing control stage may be provided for respective enzymes to be applied in a prepared composition. Alternatively, selection and dosing operations may be performed with respect to a plurality of enzymes mixed together to form an enzyme product by a single dosing control stage within the scope of the present disclosure.

An array of sensors 102, for example including online sensors 102, are linked to the dosing control stage 106 along with data storage 104, for example including one or more databases 104 with models, algorithms, and data for implementing the methods and operations as disclosed herein. Outputs from the dosing control stage may include dosing information 108 provided to a pulp or paper production stage 110, which further provides feedback information 112 to the dosing control stage. The feedback 112 from the production stage 110 is illustrated independently with respect to the array of sensors 102, but it may be understood that the feedback 112 may include signals from the array of sensors. The dosing control stage 106 may further provide feedback information 114 to the data storage 104, for example in the context of model improvement via observation and machine learning.

The term “sensors” may include, without limitation, physical level sensors, relays, and equivalent monitoring devices as may be provided to directly measure values or variables for associated process components or elements, or to measure appropriate derivative values from which the process components or elements may be measured or calculated. The term “online” as used herein may generally refer to the use of a device, sensor, or corresponding elements proximally located to a container, machine or associated process elements, and generating output signals substantially in real time corresponding to the desired process elements, as distinguished from manual or automated sample collection and “offline” analysis in a laboratory or through visual observation by one or more operators.

As noted above, the present disclosure may particularly refer to online sensors which generate output signals representative of enzymatic activity for making correlations with action on varying fiber sources. Enzymatic activity sensors for enzymes that are applicable to the pulp and paper industry may for example include those that can monitor the activity of enzymes such as, but not limited to, cellulase, xylanase, mannanase, galactase lipase, esterase, and amylase.

One of skill in the art may appreciate that these enzymes have catalytic behavior on varying substrates such as, but not limited to, cellulose, hemicellulose, triglycerides, ester-containing polymers, and starch. Methods of detection may include the incorporation of a substrate, through any type of coating, upon which these specific enzymes act.

Various types of electrochemical methods such as electrochemical impedance spectroscopy (EIS), cyclic voltammetry, amperometry, etc., may be used to determine how the film on the substrate has been changed after enzymatic action, substantially in real-time. Such techniques, along with others as further described herein, may further be applied offline for use in developing models correlating enzyme activity with various process characteristics, product properties, and the like.

In one illustrative and non-limiting example, electrochemical methods were used to determine enzyme activity on a cellulose coated gold/silicon wafer. The silicon wafer, with a thin gold surface, was placed inside a spin-coater using 2000 rpms for 60 seconds, and approximately 200 microliters (possibly more depending on the size of the wafer) of a cellulose-like substance was dissolved in tetrahydrofuran and allowed to coat the substrate.

Substrates were rinsed with deionized water and dried in nitrogen. The composition of the surface was analyzed with Fourier transform infrared spectroscopy (FTIR) and contact angle measurements. Surfaces could either be used as spin-coated or the silyl groups cleaved by placing the substrate in a petri dish with a very small amount of acid (HCl) for short periods of time and then reanalyzed by FTIR and contact angle measurements to determine surface chemistry.

Coated substrates were either used as a negative control (with no enzyme treatment) or with various enzyme treatments for various lengths of time to determine the change in resistance of the cellulose-modified surface over time. For measurements, the coated surfaces that had enzyme treatment or no enzyme treatment were placed into an electrochemical device with a platinum counter electrode and a reference electrode using 1 mM ferri-and ferro-cyanide together with 5 mM citrate buffer with salts at pH 6 to determine changes in resistance by varying frequency from 0.1 to 1000 Hertz.

The coated surface demonstrated a high film resistance with a high value of Zmod (ohms). After exposure to an enzyme-based product, a reduction in film resistance occurred after 20 minutes at room temperature. To make sure that the resistance of the film was not changing simply due to water exposure, the same substrate that had previously been exposed to 20 minutes of enzyme was rinsed and then exposed to 20 minutes of water without noticing any decrease in film resistance. Afterwards, the same substrate was again exposed to 20 minutes of enzyme and the film resistance again decreased demonstrating that an electrochemical signal can be used to determine enzyme activity/performance on a substrate modified with a chemical functionality specific to the catalysis of each enzyme.

Electrochemical measurements may be made before and after exposure to enzymes in real-time while monitoring changes in impedance of the surface film. These enzymatic sensors, and processing of the output signals therefrom, may enable distinguishing of enzymes within products that can act on amorphous or crystalline cellulose based on coating methodology such as Langmuir Blodgett films versus spin coated films of cellulose. Accordingly, a product and dose rate selection process as discussed further below may be performed at least in part based on varying the type of cellulose coating methods to modify the type of structure of cellulose onsite at an industrial facility.

Regarding another embodiment for detecting or otherwise estimating enzymatic activity, alternatively or in addition to electrochemical methods among others, detection of enzyme activity and performance of a cellulase on fibers can also be performed using glucose sensors both in real-time and periodically. One of skill in the art may for example appreciate that cellulose, comprised of glucose, can be broken down into reducing sugars through the use of cellulase enzymes. Though levels of glucose would be expected to be low, sensors that can detect glucose at low levels can be incorporated into monitoring of machine chests, repulpers, or white-water lines wherein enzymes would be recirculated to correlate with both activity of enzymes on fibers and the ability to determine effective doses. The use of glucose detection is considered within the scope of the present disclosure as a potential tool for understanding enzymatic activity in real-time, e.g., on pulp.

Accordingly, various embodiments as disclosed herein may enable much needed process control for, e.g., a pulp or paper mill if bacterial levels become high and produce glucose. While some bacterial contamination within the water system of a mill can also potentially contribute to glucose levels, adding multiple sensors such as those that do not work based on glucose detection can help mitigate or prevent the need for additional biocide if the levels become higher than those expected with a non-glucose detecting sensor.

Exemplary glucose sensors within the scope of the present disclosure may include those that incorporate glucose oxidase or other means known to one of skill in the art for glucose detection, including indirect methods, such as optical spectroscopy, infrared spectroscopy, and methods incorporated by diabetics such as Dexcom G7, Dexcom Stelo Glucose Biosensor, FreeStyle Libre, Jobst Technologies Biosensors, and the like. In one particular and non-limiting example, experiments were performed on bleached softwood using a glucose sensor to determine in real-time the glucose concentration generated with enzyme product exposure to the fiber at a 1.6% consistency in citrate buffer at pH 6 and 42° C. The bleached softwood was continuously stirred with a Phipps and Bird stirring apparatus and stainless-steel mesh contained the pulp so that a smaller tube could be placed on the outside of the mesh and connected to a peristaltic pump set at 10 mL/min to flow through a glucose sensor. Prior to the run, the sensor was calibrated with a buffered solution of glucose with salts.

Three experiments were conducted at three different concentrations of enzyme product, namely, 1 kg/ton, 10 kg/ton, and 100 kg/ton. Glucose signals were as expected, lower for the lower dosages and higher for the higher dosages, with immediate results seen at 10 kg/ton and 100 kg/ton. To confirm that the signal from the sensor was not impeded by any water with small fiber particulate, the pump was stopped at about 160 minutes and the tubing switched to citrate buffer alone with no glucose, whereupon the signal immediately dropped to zero. After some time, the tubing was again placed back into the pulp solution, whereupon the glucose signal was regained and continued to increase with time. This trend was observed for both the 10 kg/ton dosage and the 100 kg/ton dosage. Enzyme activity/performance upon fibers can be detected and determined using a glucose sensor.

Methods to detect glucose in fiber solutions with lower dosages may in some embodiments include a concentrating step prior to glucose sensing for example boiling samples to concentrate down reducing sugars and the utilization of more sensitive glucose-based sensors in order to obtain a faster detection/response time.

Another illustrative and non-limiting embodiment may involve testing for enzyme activity, for example cellulase and xylanase enzyme activity, using tablets such as Megazyme/Neogen Cellazyme C, Xylazyme, Amylazyme, Mannazyme, Galactazyme, Protozyme, and the like, with respect to pulp product, for example optionally, in the alternative, or supplemental to any other techniques as disclosed herein. In association with one example of this technique, an enzyme product was dosed at a particular rate and kept constant. Determining the actual dosage of enzyme products over time is beneficial in determining the effective enzyme concentration, activity, and performance of the product on the fiber. Pulp was treated in the lab to generate a standardized curve and then tested at the paper mill to determine enzyme activity and translate that to an enzyme dosage (concentration). A known consistency of pulp (OCC) was used to test various concentrations of enzyme product at 50° C. with stirring for one hour. The pulp was filtered with a fine mesh screen and the filtrate kept. The filtrate was then poured into 10 mL containers with a Megazyme/Neogen Cellazyme C tablet placed for various times, which releases a blue dye upon enzymatic action that is read at a set wavelength. After a set incubation time, the solution was filtered through a Whatman PVDF syringe filter and the color read at a set wavelength. As the enzyme concentration is increased, the level of absorbance is increased. Enzyme dosages and activity can be determined by collecting samples at various locations within the mill using a standard curve generated on pulp that had not had any enzymatic treatment.

It may be appreciated that the above-referenced technique is described as being performed over a period of minutes or hours, but in some variants could become more immediately responsive with the implementation of an online system that ties to an enzyme dosing skid.

In an embodiment, substrates coated with cellulose acetate may for example be used to detect the activity of esterases on the exposed acetyl groups.

In an embodiment, starch coated substrates may be used to detect the presence of amylase, triglyceride-based surfaces for lipases, and the like.

Other examples of online sensors 102 are well known in the art for the purpose of sensing or calculating characteristics such as temperature, flow rate, ORP, conductivity, biocide residual, pH and the like, and exemplary such sensors are considered as being fully compatible with the scope of a system and method as disclosed herein.

Individual sensors may be separately mounted and configured, or the system 100 may provide a modular housing which includes, e.g., a plurality of sensors or sensing elements. Sensors or sensor elements may be mounted permanently or portably in a particular location respective to the production stage 110 or may be dynamically adjustable in position so as to collect data from a plurality of locations during operation.

Online sensors 102 as disclosed herein may provide substantially continuous measurements with respect to various process components and elements, and substantially in real-time. The term “continuous” as used herein, at least with respect to the disclosed sensor outputs, does not require an explicit degree of continuity, but rather may generally describe a series of measurements corresponding to physical and technological capabilities of the sensors, the physical and technological capabilities of the transmission media, the physical and technological capabilities of any intervening local controller, communications device, and/or interface configured to receive the sensor output signals, etc. For example, measurements may be taken and provided periodically and at a rate slower than the maximum possible rate based on the relevant hardware components, or based on a communications network configuration which smooths out input values over time, and still be considered “continuous.” Likewise, the term “real-time” as used herein does not require an explicit degree of immediacy, but rather may in various contexts encompass measurements, functions, operations, or the like which take place over a period of time but are undertaken without delay. For example, measurements which are initiated at a first time and are not practically able to be completed until a second time, but are performed without delays in the interim, may be treated as real-time within the scope of the present disclosure, even if the difference between the first and second times may be defined in minutes or even hours depending on the context.

A user interface (not shown) may further enable users such as operators, administrators, and the like to provide periodic input with respect to conditions or states of additional components of relevance to models, algorithms, or the like as further discussed herein. The user interface may be in functional communication with the dosing control stage 106, a distributed control system (not shown) associated with the industrial facility, and/or a remote hosted server (not shown) to receive and display process-related information, or to provide other forms of feedback with respect to, e.g., control processes as further discussed herein.

An embodiment of a system including, embodied by, or otherwise associated with the dosing control stage 106 may include a first computing device or network, for example a data center, server network, or the like, including input/output devices, one or more processors functionally linked, selectively or continuously, to data storage 104 associated with the first computing device, and in various embodiments to various second (client) computing devices via a communications network. Client computing devices may include respective user interfaces and processors, as well as local data storage and input/output devices. Either or both of the first and/or second computing devices may be linked to one or more online sensors 102 for providing input data relating to the models as further described herein.

Various components of a system 100 as disclosed herein, and more particularly any computing devices, controllers, and associated program modules or the like as configured to execute steps in a method 200 as further described below, may generally be programmed to request, extract, receive, translate, ingest, and otherwise process data from input/output devices, user interfaces, sensors, laboratory equipment, remote/third party devices, or the like via manual upload, application program interfaces, etc. Communication buses, networks, and the types and formats of such data may be well understood by those of skill in the art.

The term “user interface” as used herein may unless otherwise stated include any input-output module with respect to the controller and/or the hosted data server including but not limited to: a stationary operator panel with keyed data entry, touch screen, buttons, dials or the like; web portals, such as individual web pages or those collectively defining a hosted website; mobile device applications, and the like.

An exemplary input/output device may refer to or otherwise include one or more devices as a part of a communication unit configured to support or provide communications between computing devices and external sensors, systems, and/or devices, and/or support or provide communication interface with respect to internal components of the computing devices. The communication unit may include wireless communication logic and system components (e.g., via cellular modem, WiFi, Bluetooth, or the like) and/or may include one or more wired communications terminals such as universal serial bus ports. In various embodiments, the communication unit may communicate over a controller area network (CAN) bus (or another network, such as an Ethernet network, etc.) to communicate information between one or more of the above-referenced elements.

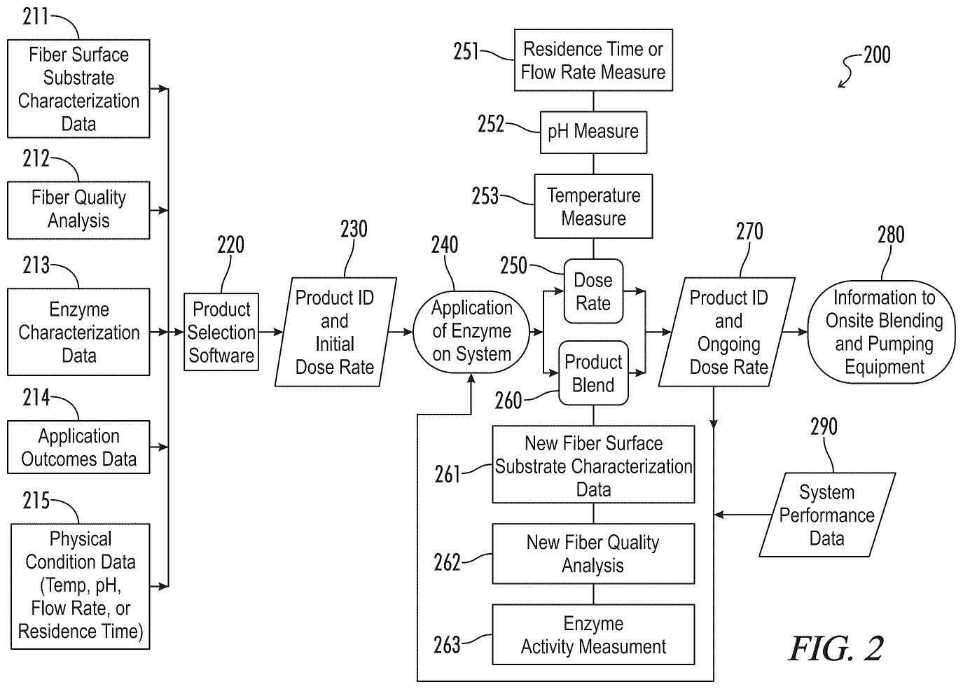

An embodiment of a method 200 may now be described with reference to FIG. 2, the illustrated steps in which are merely exemplary and not intended as expressly limiting the scope of the present disclosure unless otherwise specifically stated. One of skill in the art may further appreciate that alternative embodiments of the method 200 may include fewer or additional steps, and that certain disclosed steps may for example be performed in different chronological order or simultaneously.

The method 200 may be performed with respect to a system 100 as described above in various forms, with an exemplary objective to achieve a faster real-time online enzymatic activity measurement, and which in conjunction with data (both from prior laboratory testing and real-time pulp or paper mill paper property testing) can provide assurance that the enzyme is active, acting on the substrate source, and providing the intended function.

By monitoring the effects of enzymatic activity on substrates as they are processed in the pulp or paper mill, a prediction of paper properties prior to the final stage of market pulp can allow for quick on-the-fly adjustment. By knowing what that optimal dosage is in real-time, the operator at the mill may implement mechanical measures to provide enhanced enzyme benefit.

Another benefit of the method 200 as described herein may include that if an enzymatic product fails while at a pulp or paper mill, real-time monitoring of the enzymatic activity will give a better understanding as to whether a possible enzyme inhibitor may be present in the water composition, the pH or temperature were out of range for good enzyme function, the enzyme does not have a high substrate affinity for the particular fiber source, or the like. In some embodiments, output signals corresponding to actual or proposed interventions or alerts may be electronically generated if the enzymatic activity is not within the desired specifications.

As represented in FIG. 2, various inputs 211-215 are provided for initial product selection 220, which may refer to selection of each enzyme to be applied, to one of a plurality of enzymes to be applied, or for example to an enzyme blend further incorporating one or more aids such as a non-enzymatic potentiator, non-ionic surfactants, or the like.

Fiber surface substrate characterization data 211 may in various embodiments be selectively extracted from a database communicatively linked to the dosing controller. Numerous conventional techniques are known for characterizing the fiber surface substrate in a manner that aids enzyme selection and formulation, and such techniques may be considered within the scope of the present disclosure and in combination with one or more other inputs as further described herein. Numerous techniques are conventionally known for fiber surface characterization, including for example X-ray photoelectron spectroscopy (XPS), scanning electron microscopy (SEM), time-of-flight secondary ion mass spectrometry (ToF-SIMS), Fourier transform infra-red (FTIR), etc. However, in the context of the present disclosure it may be preferred to utilize techniques for rapid characterization of fiber surface polymers that would better enable the prediction of the impact of various treatments on pulp or paper. An exemplary sensor (detection probe) and methods of use thereof as disclosed in U.S. Pat. No. 10,788,477 is incorporated herein by reference and may accordingly be implemented for such characterization within the scope of the present disclosure, or otherwise data obtained therefrom may be selectively accessible in a database for various enzyme selection and formulation steps or operations in accordance with the other inputs as described below.

Fiber quality data 212 may be collected and transmitted or uploaded to the dosing controller from one or more sensors as are known in the art, substantially in real time, and relating for example to conventional fiber quality variables such as fiber length, fiber width, fiber coarseness, fiber kink angle, fines quantity/density, fiber curl, external fibrillation, cell wall thickness, and the like. Such sensors may within the scope of the present disclosure be online measuring devices and/or automated or manually operable offline fiber image analyzers, and the like. Relevant outputs to the dosing control stage may further include raw sense signals, converted and/or derivative values thereof, machine learning classifications of sense signals, and the like.

Enzyme function characterization data 213 may for example relate to activity profiles or fingerprints as measured or otherwise retrieved from data storage in association with the given enzyme. Enzyme activity data within the scope of the present disclosure could be a combination of real-time data observed from in-line sensors in the mill or from lab-collected enzyme activity data.

Application outcomes data 214 may generally relate to observed results from system performance feedback, for example in the context of machine learning with an objective to optimize future product blends and relative dosing, but may also encompass user inputs from a user interface to for example further define, confirm, or otherwise reverse system-generated findings.

Physical conditions data 215 may be collected and transmitted or uploaded to the dosing controller in substantially real time from one or more sensors as are known in the art, relating for example to conventional variables such as temperatures, pH values, flow rates, residence times, and the like. Such sensors to provide physical conditions data may within the scope of the present disclosure be online sensors and/or manual sensors.

A product identification and initial dose rate setting stage 230 may generally be configured to utilize the aforementioned inputs, e.g., relevant fiber, enzyme, and system data points, to identify an optimum enzyme blend and initial dose rate for a selected product application.

Such an identification may be directly ascertained from predetermined or otherwise manually input parameters associated with the optimum enzyme blend and initial dose rate for the selected product application.

Such an identification may alternatively be a predicted optimum enzyme blend and initial dose rate for the selected product application, based for example on outputs from machine learning models and associated algorithms which may have been iteratively developed over time from input data sets corresponding to the aforementioned inputs (e.g., relevant fiber, enzyme, and system data points) and further labeled inputs for performance data corresponding to previously utilized enzyme blends and dose rates. Accordingly, for a current array of inputs, such a model may (having been sufficiently trained) be configured to predict an optimum enzyme blend and initial dose rate as corresponding to previous enzyme blends and dose rates which produced desired performance data for the same (or equivalent) conditions.

In an embodiment, a machine learning model may include variable governing parameters which are optimized during training to better simulate (or approximate in a particular simulation) observed real-life performance data corresponding to an input dataset (e.g., 211-215). Such variables may comprise hyperparameters that may initially be set (e.g., user-specified) before training. Tuning of the hyperparameters, or in other words optimizing the values thereof, follows during training to obtain a set of values for the hyperparameters corresponding to an accurate input-output mapping of the model for the training dataset. In various embodiments, tuning of parameters may be performed automatically during or between training iterations, manually based on user selection via a system interface, or combinations thereof.

The next stage 240 and associated sub-steps collectively refer to application of selected enzyme(s) on the process, with a newly specified dose rate 250 and product blend 260. Feedback of at least enzyme activity measurements 263, or signals representative thereof, is provided for analysis and dynamic control of enzyme component selection and dose rates, optionally further including measured physical conditions from the process, including for example a measured retention time or system flow rate 251, a measured pH 252, a measured temperature 253, or the like. Additional data influencing the product blend may further include new fiber surface substrate characterization data 261, new fiber quality analysis data 262, and the like.

In an embodiment, an initial enzyme blend and dose rate may be predetermined or manually specified, as noted above, and then optionally modified at steps 250 and/or 260 to provide a newly specified enzyme blend and dose rate, for example through utilization of a predictive model also as noted above, but taking into account one or more elements of substantially real time input data 251-253, 261-263.

In another exemplary embodiment, the initial enzyme blend and dose rate may be a predicted optimal enzyme blend and initial dose rate for the selected product application, using a first predictive model as noted above, and then optionally modified at steps 250, 260 to provide a newly specified enzyme blend and dose rate, for example through utilization of a second predictive model taking into account one or more elements of substantially real time input data 251-253, 261-263.

The newly specified product and an associated ongoing dose rate 270 may be provided, along with any other information as may be determined relevant by the dosing controller, to an onsite blending and pumping controller and associated equipment 280. In an embodiment as previously noted herein, the dosing control stage 106 (or respective dosing control stages 106a, 106b for different enzymes) may be integrated with the production stage 110, for example in the context of a dosing skid with appropriate enzyme pumping equipment. In other embodiments, the dosing control stage 106 (or respective dosing control stages 106a, 106b for different enzymes) may be discrete products or components of the overall system and configured to transmit the relevant information for downstream implementation (i.e., enzyme formulation and pumping) via a communications network, e.g., either wirelessly or via integrated signals.

Feedback data comprising system performance data 290 may pertain to bleaching and/or physical qualities of the finished product (e.g., sheet) including for example strength data, porosity, caliper, crepe count, softness, freeness, drainage, and the like, as preferably obtained in real time or a reasonable approximation thereof. Such feedback may be provided to the dosing controller to determine if optimum dosing has been achieved, and subsequently to repeat steps 240 to 280 as needed to dynamically adjust the selection and/or balance of the enzymatic raw materials present over time. The system performance data may be obtained from offline or online methods, and may be accessible directly from existing process data repositories, e.g. distributed control systems (DCS).

In an embodiment, performance data feedback 290 may be provided using an app and associated interface residing upon or otherwise accessible from a user computing device, wherein for example samples from the industrial process may be submitted for remote testing and product recommendation for an identified fiber. Such an app may further or in the alternative enable user entry of results for a specified product recommendation (e.g., selected enzyme formulation), which may be used for labeling associated input data sets and otherwise correlating the formulation components and/or dose rates to provided outputs (e.g., successful, unsuccessful).

In an embodiment, the same interface, a different interface associated with the same app, or the like may be utilized to provide automated intervention alerts, recommendations, etc. to users based upon detected enzymatic activity being outside of or undesirably trending with respect to a desired range.

The performance data 290 may further be provided as feedback for iterative development of one or more predictive models and/or algorithms as noted above, for example wherein outcomes are correlated over time with associated conditions or measured inputs 211-215, 251-253, 261-263, etc. In various embodiments, performance data 290 may be utilized for selective self-labeling of respective data sets in a machine learning environment, potentially obviating the need for manual labeling in at least some contexts.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A method of automatically providing real-time dosing corrections for an industrial process wherein one or more enzymatic compositions are applied to fibers for producing a pulp or paper product, the method comprising:
for each of a plurality of pulp or paper products, developing predictive machine learning models by observing correlations over time between outcomes, associated with properties for the respective pulp or paper product, and various combinations of process inputs, comprising characteristics of a respective enzyme blend;
for a pulp or paper product to be produced via the industrial process, using an associated model to select an initial enzyme blend to be applied, and respective dose rates for one or more components thereof, based at least in part on input data comprising one or more target properties for the pulp or paper product;
upon application of the initial enzyme blend and respective dose rates for the one or more components thereof, providing real-time feedback data comprising measured values corresponding to enzyme activity of at least one of the one or more enzyme blend components;
during the industrial process, dynamically adjusting the respective dose rates for at least one of the one or more components of the enzyme blend, based at least in part on the measured enzyme activity.

2. The method of claim 1, comprising predicting an inhibitory content associated with a substrate for the pulp or paper product, and selecting the initial enzyme blend to be applied, and respective dose rates for one or more components thereof, based at least in part on the predicted inhibitory content.

3. The method of claim 1, wherein the one or more target properties comprise an expected fiber surface substrate characterization for the pulp or paper product, and/or an expected fiber quality characterization for the pulp or paper product.

4. The method of claim 3, comprising:
dynamically selecting a replacement enzyme blend to be applied, and respective dose rates for one or more components thereof, based at least in part on the measured enzyme activity and further on a predicted one or more target properties of the pulp or paper product corresponding to the replacement enzyme blend; and
applying the selected replacement enzyme blend in place of at least a portion of the initial enzyme blend during the industrial process.

5. The method of claim 4, comprising predicting an inhibitory content associated with a substrate for the pulp or paper product, and selecting the replacement enzyme blend to be applied, and respective dose rates for one or more components thereof, based at least in part on the predicted inhibitory content.

6. The method of claim 1, comprising generating and retrievably storing correlations between at least measured enzyme activity and respective types of fiber surface substrates.

7. The method of claim 1, wherein the real-time feedback data comprises glucose detection signals and non-glucose enzyme activity detection signals.

8. The method of claim 1, wherein the real-time feedback data corresponds to measured actual values of byproducts produced by enzymatic reactions associated with at least one of the one or more enzyme blend components.

9. The method of claim 1, wherein the real-time feedback data corresponds to measured changes in electrochemical signals upon enzyme exposure.

10. The method of claim 1, wherein the real-time feedback data corresponds to measured changes in impedance of a substrate surface coating upon enzyme exposure.

11. The method of claim 10, wherein the substrate is coated with a cellulose derived coating.

12. The method of claim 10, wherein the substrate is coated with a starch.

13. The method of claim 1, wherein the initial enzyme blend to be applied and the respective dose rates are selected further based on expected values for one or more industrial process characteristics, and the real-time feedback data further comprises measured values for the one or more industrial process characteristics.

14. The method of claim 1, further comprising selectively altering the predetermined model based at least in part on the provided real-time feedback data.

15. A system for automatically providing real-time dosing corrections in an industrial process wherein one or more enzymatic compositions are applied to fibers for producing a pulp or paper product, the system comprising:
a data storage unit comprising, for each of a plurality of pulp or paper products, predictive machine learning models correlating outcomes, associated with properties for the respective pulp or paper product, and various combinations of process inputs, comprising characteristics of a respective enzyme blend;
one or more online sensors configured to generate output signals representative of measured actual values for enzyme activity of at least one of one or more enzyme blend components during the industrial process;
a production stage comprising a plurality of containers each configured to store and selectively deliver respective raw materials corresponding to selected enzyme blend components; and
a dosing control stage comprising one or more computing devices functionally linked to the data storage unit and to the one or more online sensors and configured to cause the performance of the steps during the industrial process in the method of claim 1.

16. The system of claim 15, wherein the one or more computing devices are configured to predict an inhibitory content associated with a substrate, and select the initial enzyme blend to be applied, and respective dose rates for one or more components thereof, based at least in part on the predicted inhibitory content.

17. The system of claim 15, wherein the one or more sensors are configured to provide glucose detection signals and non-glucose enzyme activity detection signals.

18. The system of claim 15, wherein the output signals from the one or more sensors correspond to measured actual values of byproducts produced by enzymatic reactions associated with at least one of the one or more enzyme blend components.

19. The system of claim 15, wherein the initial enzyme blend to be applied and the respective dose rates are selected further based on expected values for one or more industrial process characteristics, and the real-time feedback data further comprises measured values for the one or more industrial process characteristics.

20. The system of claim 15, wherein the selected initial enzyme blend and the dynamically selected replacement enzyme blend to be applied, and respective dose rates thereof, are provided to a pulp bleaching process controller or a paper manufacturing controller.
